(19) United States
(12) Patent Application Publication
(10) Pub. No.: US 2007/0182888 A1
(43) Pub. Date: Aug. 9, 2007

(54) LIQUID CRYSTAL DISPLAY DEVICE

(75) Inventors: Hiroharu INOUE, Fukaya-shi (JP); Takeshi Yamamoto, Fukaya-shi (JP); Atsuyuki Manabe, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 11/626,546

(22) Filed: Jan. 24, 2007

(30) Foreign Application Priority Data
Feb. 3, 2006 (JP) 2006-027538
Oct. 23, 2006 (JP) 2006-287059

(51) Int. Cl. G02F 1/1335; G02F 1/1339

(52) U.S. Cl. 349/106; 349/156

(57) ABSTRACT

A projection pattern is formed so as to project to a colored film to which a part of colored film on an array substrate is adjacent. A recess pattern corresponding to the projection pattern is formed to the adjacent colored film. A columnar spacer is formed on the projection pattern. The columnar spacer does not override a color overlap portion of the colored films, and thus the variation in a cell gap between the array substrate and the counter substrate can be suppressed.

### INCORPORATION BY REFERENCE

The present application claims priority under 35 U.S.C. §119 to Japanese Patent Application Nos. 2006-027538 filed on Feb. 3, 2006 and 2006-287059 filed on Oct. 23, 2006. The content of the application is incorporated herein by reference in their entirety.

### FIELD OF THE INVENTION

The present invention relates to a color filter on array (COA) type liquid crystal display device.

### BACKGROUND OF THE INVENTION

Liquid crystal display devices are constructed so that a liquid crystal layer is sandwiched between two glass substrates having electrodes, the peripheries of the two glass substrates are fixed to each other by adhesive agent except for a liquid crystal sealing port and the liquid crystal sealing port is sealed by a sealing member. Furthermore, a spacer for keeping the distance between the two glass substrates constant is disposed on the substrates.

In a liquid crystal display device for color display out of these liquid crystal display devices, RGB colored films are formed on one of the two glass substrates. For example, as a liquid crystal display device using a color type active matrix driving method, known is a COA type liquid crystal device provided with a semiconductor layer including thin film transistors (Thin Film Transistor, hereinafter referred to as “TFT”) formed of a semiconductor such as polysilicon, amorphous silicon or the like, an array substrate on which pixel electrodes are connected to the semiconductor layer, source electrodes and gate electrodes being formed, and a counter electrode disposed so as to face the array substrate, colored films of RGB being formed on the array substrate as disclosed in Japanese Laid-Open Patent Publication No. 2000-171784.

In the COA type liquid crystal display device 1 of the above first related art, as shown in FIG. 9 and FIG. 10, a columnar spacer 2 is formed on the overlap portion of the colored films 4R, 4G and 4B on the cross portion between a signal line 3s and a scan line 3g. However, variation occurs in the height of the overlap portion of the colored films 4R, 4G and 4B, and thus there is a problem that the variation in a cell gap between the array substrate and the counter substrate is increased.

The present invention has been implemented in view of the foregoing point, and has an object to provide a liquid crystal display device that can suppress the variation in a cell gap between the array substrate and the counter substrate.

### SUMMARY OF THE INVENTION

A liquid crystal display device according to the present invention is provided with: an insulating substrate; a plurality of scan lines and a plurality of signal lines arranged in a matrix form on the insulating substrate; a switching active element that is provided for every pixel at each cross portion of the scan lines and the signal lines and connected to each of the scan lines and each of the signal lines; colored films of a plurality of colors formed on the switching active element; an array substrate having pixel electrodes that are formed on the colored films and driven by the switching active elements; a first pattern formed in the colored film; and a second pattern that is formed in the colored film and fitted to the first pattern formed in a colored film adjacent to the colored film, in which the first pattern of at least any one of the colored films is a projection pattern projecting to the adjacent colored film, and has a columnar spacer formed on the projection pattern.

According to the present invention, the first pattern is formed in the colored film, and the second pattern fitted to the first pattern of the adjacent colored film is formed. At least any first pattern is set as a projection pattern projecting to the adjacent colored film, and the columnar spacer is provided to the projection pattern, whereby the columnar spacer does not override the color overlap portion of the colored films, and thus the variation in a cell gap between the array substrate and the counter substrate can be suppressed.

### BRIEF DESCRIPTION OF THE DRAWINGS

FIG. 1 is a plan view showing a liquid crystal display device according to a first embodiment of the present invention,

FIG. 2 is a longitudinally-sectional view taken along a line X1-X2 of FIG. 1,

FIG. 3 is a enlarged plan view of the main part of an array substrate of FIG. 2,

FIG. 4 is a longitudinally-sectional view taken along a line X3-X4 of FIG. 1,

FIG. 5 is a plan view showing a liquid crystal display device according to a second embodiment of the present invention,

FIG. 6 is an enlarged plan view of the main part of the array substrate of the liquid crystal display device,

FIG. 7 is an enlarged plan view showing the main part of the liquid crystal display device according to a third embodiment of the present invention,

FIG. 8 is an enlarged plan view showing the main part of the liquid crystal display device according to a fourth embodiment of the present invention,

FIG. 9 is a plan view showing an array substrate of a related art, and

FIG. 10 is a longitudinally-sectional view taken along a line X5-X6 of FIG. 9.

### DETAILED DESCRIPTION OF THE PREFERRED EMBODIMENTS

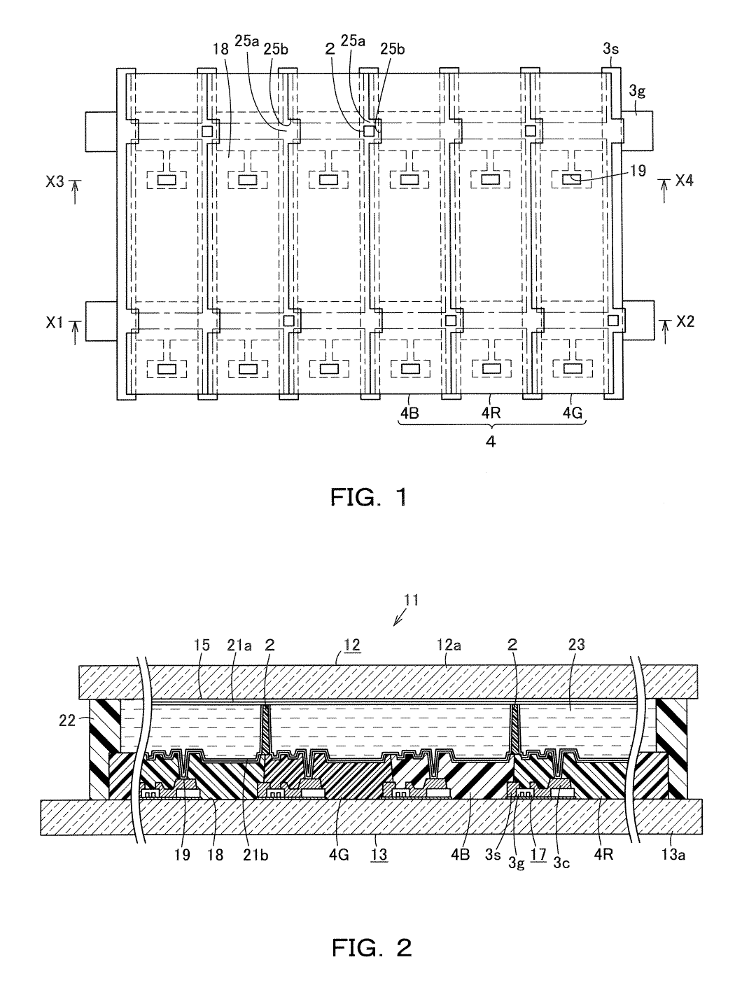

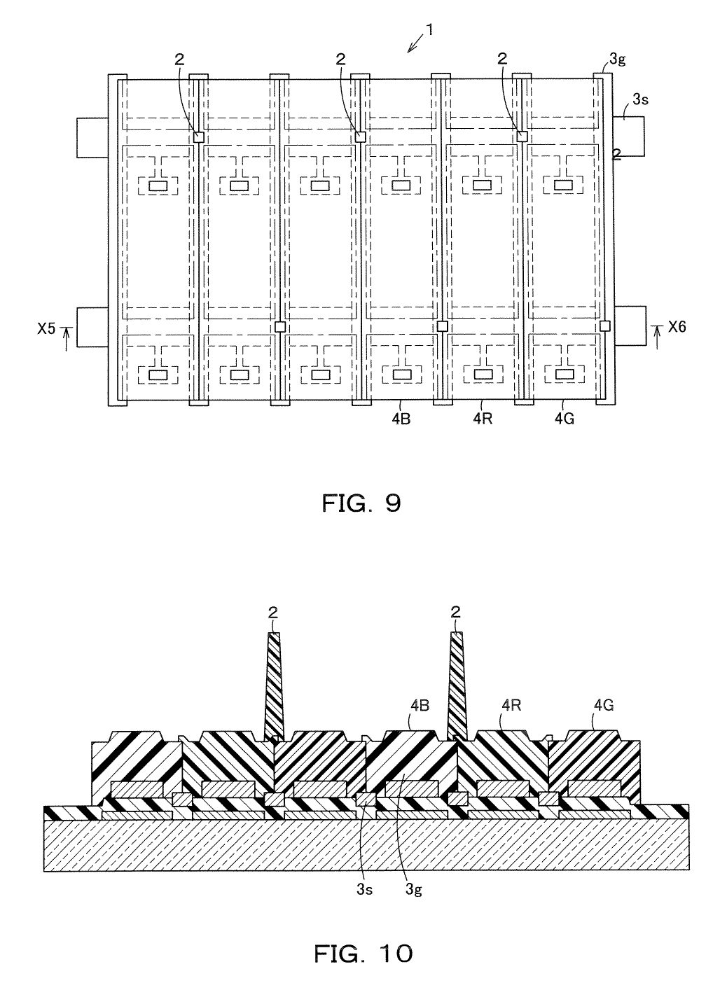

A liquid crystal display device according to a first embodiment of the present invention will be described with reference to FIG. 1 to FIG. 4. The same constituent elements as the liquid crystal display device of the related art shown in FIG. 9 and FIG. 10 are represented by the same reference numerals, and the description thereof is omitted.

As shown in FIG. 1 and FIG. 2, a liquid crystal display device 11 has a counter substrate 12 and an array substrate 13 on which colored films 4R, 4G and 4B are formed by patterning. In the following description, any one of the colored films 4R, 4G and 4B or all the colored films may be referred to as colored film 4.

In the counter substrate 12, a transparent electrode 15 is formed on a glass substrate 12a.

In the array substrate 13, signal lines 3s are wired on the glass substrate 13a as an insulating substrate in the longitudinal direction in FIG. 1, and scan lines 3g and auxiliary capacitors 3c are arranged in a matrix form so as to cross the signal lines 3s. TFTs 17 as switching active elements are formed in the vicinity of the cross portions of the signal lines 3s and the scan lines 3g. Furthermore, the colored films 4R, 4G and 4B are respectively formed on the TFTs 17, and a pixel electrode 18 having a required pattern is formed on the colored films 4R, 4G and 4B. The pixel electrode 18 and the TFT 17 is electrically conducted to each other through a contact hole 19 formed in the colored films 4R, 4G and 4B.

The columnar spacers 2 are formed to have a desired pattern and a desired height by resist coating, exposure, development and post baking.

Furthermore, as shown in FIG. 2, orientation films 21a and 21b are formed on the facing surfaces of the counter substrate 12 and the array substrate 13, and they are rubbed to carry out an orientation treatment.

The peripheral portions of the array substrate 13 and the counter substrate 12 are fixed to each other by a seal member 22, and liquid crystal 23 is filled via the columnar spacers 2, thereby forming the liquid crystal display device 11.

A deflection plate is attached to both the surfaces of the panel in accordance with an application of the liquid crystal display device 11.

A method of manufacturing the constructed array substrate 13 will be described.

In a first step, array wires 3 (signal lines 3s, scan lines 3g, auxiliary capacitors 3c, etc.) are formed on the glass substrate 13a.

In a second step, TFTs 17 are formed on the glass substrate 13a by repeating general formation of semiconductor film, insulating film and etching based on photolithography.

In a third step, organic pigment is dispersed on the glass substrate 13a having the TFTs 17 formed thereon to form photosensitive colored resist, and then exposure and development are carried out to form the colored films 4R, 4G and 4B in a required pattern shape. At this time, the contact holes 19 are also patterned on the TFTs 17. The formation order of the colored films 4R, 4G and 4B may be arbitrary in accordance with the characteristics of the colored films 4R, 4G and 4B. The finished film thickness of the colored films 4R, 4G and 4B is set to 3.0±0.3 μm. A proximity exposure device is preferable in productivity as an exposure machine used for photolithography, however, a mirror projection exposure device is preferable to enhance the alignment precision and reduce the overlap step variation.

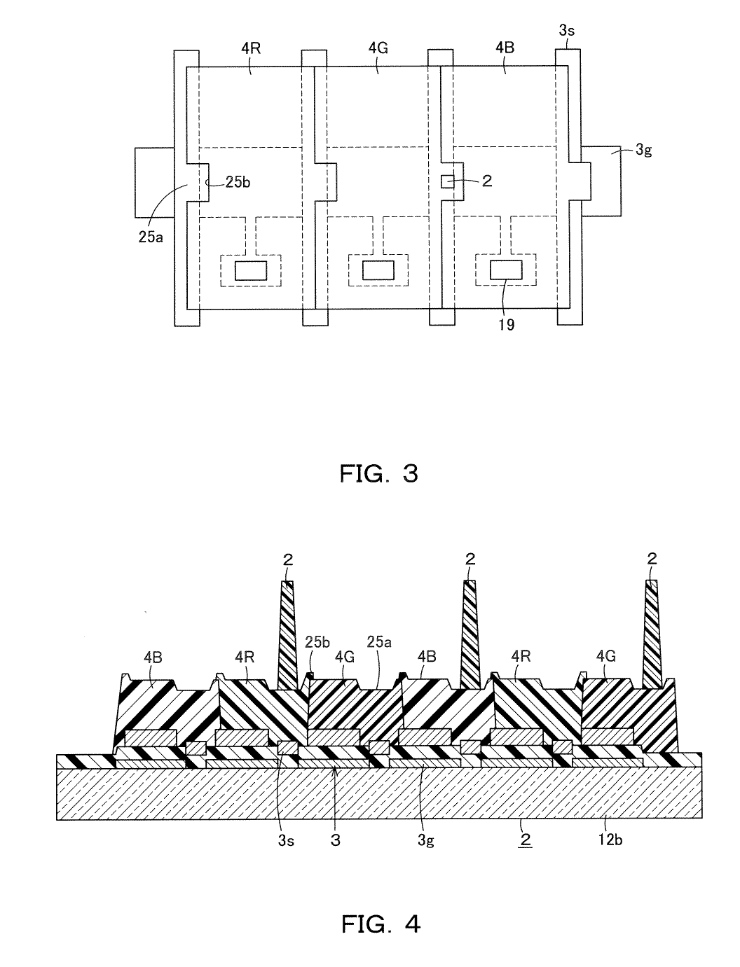

Furthermore, when the colored films 4R, 4G and 4B are formed, a planar rectangular projecting pattern 25a as a first pattern and a planar rectangular recess pattern 25b as a second pattern are formed on each of the colored films 4R, 4G and 4B to form the columnar spacers 2. Specifically, as shown in FIG. 4, the different colored films 4R and 4G are disposed so as to be adjacent to each other at the center portion of the signal line 3s, and the upper tip portion of the colored film 4R is overlapped with the colored film 4G. Then, under the state that the array substrate 13 is viewed in plan as shown in FIG. 3, the projection pattern 25a is formed so that the colored film 4R projects to the colored film 4G at the cross portion between the signal line 3s and the scan line 3g. On the other hand, the recess pattern 25b corresponding to the projection pattern 25a is formed on the colored film 4G. As shown in FIG. 4, the projection pattern 25a and the recess pattern 25b are formed over the whole area from the upper end to the lower end of the colored films 4R and 4G unlike the overlap portion. With respect to the other colored films 4, the projection pattern 25a and the recess pattern 25b are also likewise formed.

In a fourth step, a transparent electrode is formed on the whole surface of the array substrate 13 by ITO sputtering, and then the pixel electrode 18 is patterned by photolithography, whereby the pixel electrode 18 is electrically conducted to TFT 17 via the contact hole 19.

In a fifth step, resist coating, exposure, development and post baking are applied to the surface of the array substrate 13, thereby forming the projection pattern 25a on the columnar spacer 2.

In the liquid crystal display device, the projection pattern 25a and the recess pattern 25b are provided to the colored films 4R, 4G and 4B in plan view as shown in FIG. 8, and the columnar space 2 is formed on the projection pattern 25a. Accordingly, the columnar spacer 2 is designed so as not to override the color overlap portion, and thus the variation in a cell gap between the array substrate 13 and the counter substrate 12 can be suppressed.

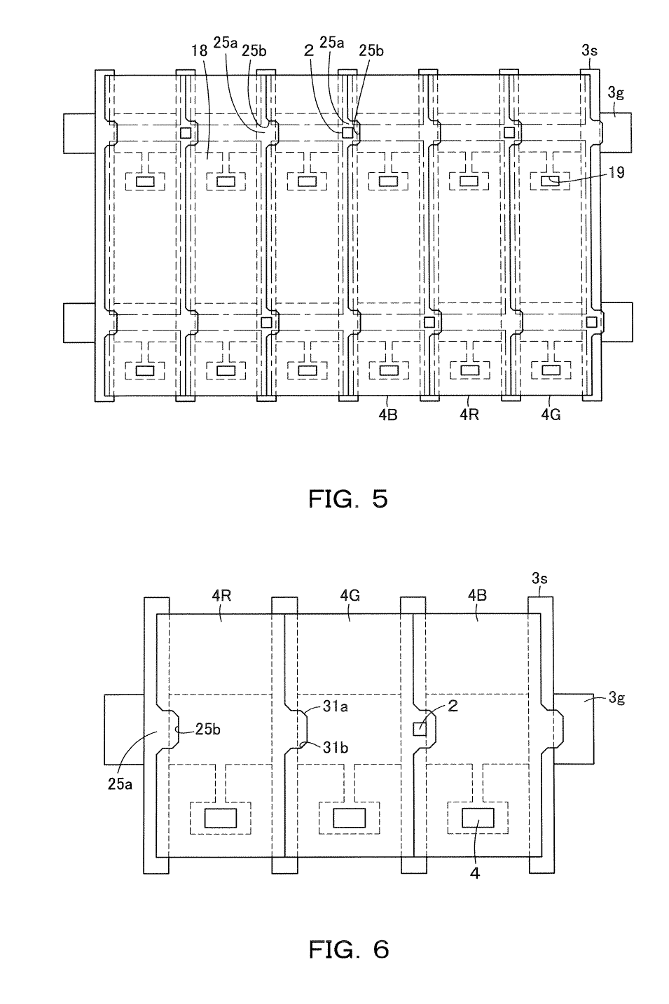

Next, the liquid crystal display device according to a second embodiment will be described with reference to FIG. 5 and FIG. 6. The same constituent elements as the first embodiment are represented by the same reference numerals, and the description thereof is omitted.

According to the second embodiment, the corner portion 31a of the projection pattern 25a and the corner portion 31b of the recess pattern 25b of the first embodiment are designed to have obtuse angles.

For example, in the third step of the manufacturing method of the liquid crystal display device, the projection pattern 25a is formed from the colored film 4R, and the right-angle corner portions thereof are incised at an angle of 45 degrees in the slant direction connecting two points on both sides of each right-angled corner portion which are respectively spaced from the apex of the corner portion by 3 μm, thereby forming two corner portions of 135°.

According to the present embodiment, the same operation and effect as the first embodiment can be achieved, and also the corner portion 31a of the projection pattern 25 is designed to have an obtuse angle which is larger than 90° and less than 180°. Accordingly, film exfoliation caused by an over phenomenon or the like due to the process variation in the development step, for example, can be suppressed from occurring at the corner portions 31a, 31b of the projection pattern 25a and the recess pattern 25b provided to the colored films 4R, 4G and 4B, and thus the array wires 3 below the colored films 4 can be prevented from being exposed. Accordingly, even when the tips of the corner portions 31a and 31b of the projection pattern 25a and the recess pattern 25b of the colored films 4R, 4G and 4B are designed so as to override the steps of the base layer such as the array wires 3, etc., the pixel electrodes 18 formed in the next step and the array wires 3 as the lower layer of the colored films 4R, 4G and 4B can be prevented from being short-circuited. Therefore, failure of luminescent spots in the liquid crystal display device 11 can be eliminated and thus the yield can be enhanced.

Even when the tip portions of the projection pattern 25a and the recess pattern 25b are designed so as to override the steps of the base layer, the film exfoliation can be prevented by making the angle obtuse.

Furthermore, the effect can be achieved by setting the angle of the corner portion 31a of the projection pattern 25a to an obtuse angle which is larger than 90° and less than 180°, however, the angle is preferably as large as possible insofar as it is permitted by design.

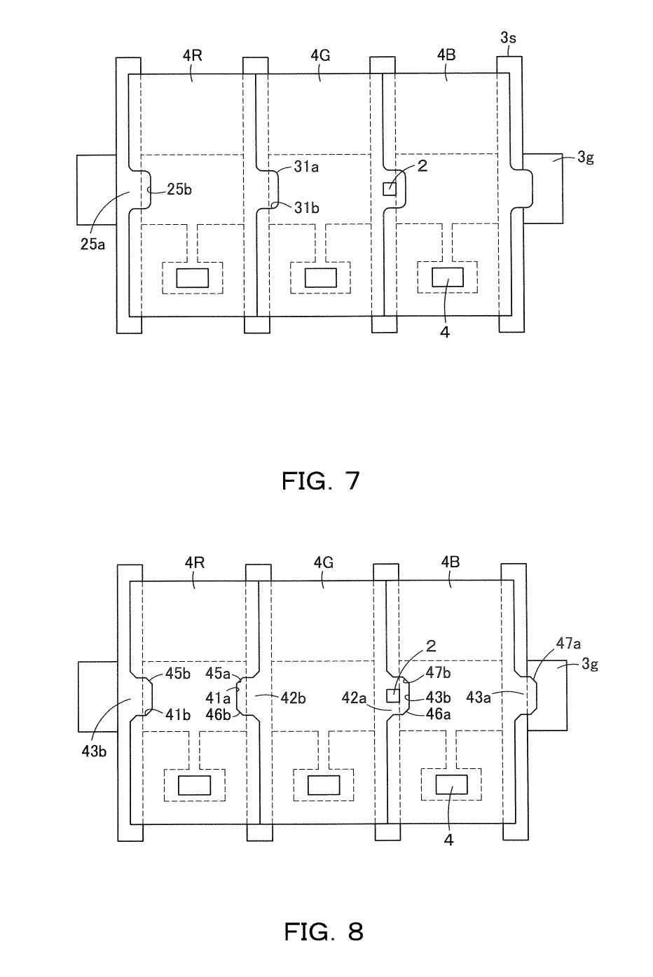

Next, the liquid crystal display device according to a third embodiment will be described with reference to FIG. 7. The same constituent elements as the above-described embodiments are represented by the same reference numerals, and the description thereof is omitted.

In the third embodiment, the corner portions 31a and 31b of the projection pattern 25a and the recess pattern 25b of the colored films 4R, 4G and 4B are designed in an arcuate shape having a curvature radius of 5 μm.

Accordingly, the same effect as the second embodiment in which the corner portions 31 of the projection pattern 25a and the recess pattern 25b are designed to have an obtuse angle can be obtained. The curvature radius of the arcuate shape is set to 5 μm, however, this value is preferably as large as possible insofar as it is permitted by design.

Next, the liquid crystal display device according to a fourth embodiment will be described. The same constituent elements as the above-described embodiments are represented by the same reference numerals, and the description thereof is omitted.

According to the fourth embodiment, in the second embodiment, a recess pattern 41a as the first pattern and a recess pattern 41b as a second pattern are formed in the colored film 4R, a projection pattern 42a as a first pattern and a projection pattern 42b as a second pattern fitted to the recess pattern 41a are formed in the colored film 4G, a projection pattern 43a as a first pattern, and a recess pattern 43b as a second pattern fitted to the projection pattern 42a are formed in the colored film 4B, and the columnar spacer 2 is formed on the projection pattern 42a.

Furthermore, the corner portions 45a and 45b of the recess patterns 41a and 41b, the corner portions 46a and 46b of the projection pattern 42a and 42b and the corner portions 47a and 47b of the projection pattern 43a and the recess pattern 43b are designed to have obtuse angles as in the case of the corner portions 31a and 31b of the second embodiment.

Accordingly, the same effect as each of the above-described embodiments can be achieved.

In the fourth embodiment described above, it is a matter of course that the same effect can be achieved even when the corner portions 45a, 45b, 46a, 46b, 47a, and 47b are designed so as not to have obtuse angles as in the case of the first embodiment or even when the corner portions 45a, 45b, 46a, 46b, 47a, and 47b are designed in the arcuate shape as in the case of the third embodiment.

Furthermore, the present invention is not limited to the above-described embodiments, and various modifications may be made without departing from the gist of the present invention.

What is claimed is:

1. A liquid crystal display device comprising:
an insulating substrate;
a plurality of scan lines and a plurality of signal lines arranged in a matrix form on the insulating substrate;
a switching active element that is provided for every pixel at each cross portion of the scan lines and the signal lines and connected to each of the scan lines and each of the signal lines;
colored films of a plurality of colors formed on the switching active element;
an array substrate having pixel electrodes that are formed on the colored films and driven by the switching active elements;
a first pattern formed in the colored film; and
a second pattern that is formed in the colored film and fitted to the first pattern formed in a colored film adjacent to the colored film, wherein the first pattern of at least any one of the colored films is a projection pattern projecting to the adjacent colored film, and has a columnar spacer formed on the projection pattern.

2. The liquid crystal display device according to claim 1, wherein the first pattern and the second pattern are designed in a rectangular shape, the angles of the corner portion of the first pattern and the corner portion of the second pattern are set to obtuse angles.

3. The liquid crystal display device according to claim 1, wherein the first pattern and the second pattern are designed in a rectangular shape, and the corner portion of the first pattern and the corner portion of the second pattern are designed in an arcuate shape.

4. The liquid crystal display device according to claim 1, wherein the projection pattern is formed on the signal line.

5. The liquid crystal display device according to claim 1, wherein the projection pattern is formed on the scan line.

6. The liquid crystal display device according to claim 1, wherein the projection pattern is formed on the cross portion between the signal line and the scan line.
